(19) United States
(12) Patent Application Publication
(10) Pub. No.: US 2001/0011990 A1
(43) Pub. Date: Aug. 9, 2001

(54) HIGH RELIABILITY POINTING DEVICE FOR GRAPHICAL USER INTERFACE NAVIGATION

(76) Inventor: GREGORY HOPPER, RALEIGH, NC (US)

Correspondence Address: ANDREW J. DILLON, FELSMAN, BRADLEY, GUNTER & DILLON, LAKEWOOD ON THE PARK, SUITE 350, 7600B NORTH CAPITAL OF TEXAS HIGHWAY, AUSTIN, TX, 78731

(21) Appl. No.: 09/170,989

(22) Filed: Oct. 13, 1998

(51) Int. Cl. G09G 5/00

(52) U.S. Cl. 345/156

(57) ABSTRACT

A pointing device for a computer system, comprising a base, a joystick secured to the base, and a circular pad mounted centrally on the joystick such that manual pressure at a point near a periphery of the pad causes deflection of the joystick in a direction toward the pressure point. Appropriate electronics are used for translating a pitch angle of the joystick into electrical signals, which can then be conveyed to a controller of the computer system. An actuation button is mounted to the base to allow selection of objects on the display, or other mouse operations. The pad is located within a recessed portion of the base, and deflection of the pad is limited by an adjacent recessed surface and a rim of the base.

### BACKGROUND OF THE INVENTION

1. Field of the Invention

The present invention generally relates to computer systems, and more particularly to pointing devices for visual displays, such as those commonly referred to as a “mouse.” The present invention is directed to an improved hardware design for such a graphical pointing device.

2. Description of Related Art

A computer system includes many components, such as the central processing unit (CPU, or processor), temporary memory for storing program instructions (like random access memory, or RAM), a permanent storage device (such as a hard disk), and a variety of user-interface devices, such as a video display, a keyboard, and a pointing device which controls the movement of a graphical pointer or cursor on the display. The graphical pointer typically takes the form of an arrow having a hot spot that specifies the exact location of the pointer when the user presses one or more buttons of the pointing device. The graphical pointer is used to select certain areas on the screen, such as words in a text-only display, or icons and other graphic objects in a more complicated graphical user interface (GUI). An area or item is selected by placing the graphical pointer of the display over the area desired, and then clicking a button on the pointing device (“point-and-click”). Other operations can be performed using the graphical pointer besides simple item selection, such as “drag-and-drop” operations to move logical objects within the computer system or provide associations between objects.

The pointing device, often referred to as a “mouse,” can come in a variety of physical embodiments. The most familiar design is a hand-held unit having a ball therein which extends partially through a hole in the bottom of the unit, so that the unit can be pushed along a flat surface to cause the ball to roll. Transducers within the unit convert the motion of the ball to electrical signals which are transmitted to the processor (or a controller circuit connected to the processor) which, in turn, decodes those signals to determine how the graphical pointer on the display should be manipulated. This embodiment is referred to as a mouse since most units have a wire connecting them to the CPU which is reminiscent of the tail of a real mouse. Nevertheless, other pointing devices lacking such an appearance are still generically referred to as a mouse.

Other physical embodiments of pointer devices include a “track ball,” and electrically sensitive pads. A track ball is similar to the standard mouse in that a ball and similar transducers are provided, but the ball protrudes upwardly from a hole in a housing so that the user touches the ball directly to move it, rather than moving a hand-held unit. Electrically sensitive pads can be activated by using a finger, or by using a special stylus.

Another pointing device is sold under the trademark “Trackpoint” by International Business Machines Corp. (IBM-assignee of the present invention). The Trackpoint device operates similar to joystick actuation, with a small pointing stick that pushed in the desired direction of travel of the graphical pointer on the display. The pointing stick is mounted in the center of the keyboard to provide easy access.

Most pointing devices for computers are not well suited for use in high volume environments such as schools, libraries, airports, daycare centers, etc. They are subject to damage from accumulated debris, spills, and deliberate abuse (e.g., removal of the ball from a mouse, rendering the device unusable which often further disables the computer as a practical matter). One solution has been to put tamper-resistant screws on the “belly door,” that is, the removable panel at the bottom of the unit that is used to access the ball.

The trackball pointing device has two design implementations. In one, the ball itself may be removed from the base, which is unacceptable not only because the ball may become lost or unusable, but also because it can become a dangerous projectile in the hands of a child. In the other implementation, the ball cannot be removed from the base, but this makes cleaning the ball and interior components (the rollers that are connected to the transducers) inconvenient or impossible. Accretion of debris from hands is a known phenomenon in these environments, and it is expected that frequent ball replacement would be required when a trackball is used.

The IBM Trackpoint device has had a further problem in that it is not particularly suitable for many users, including seniors, those disabled, and young children, as it requires too much dexterity. Also, the pointing stick of these devices usually has a small rubber (gripping) tip on its ends, and removal of the tip is again a problem (and presents a choking hazard for very small children). Furthermore, use of a trackpoint that is integrated into a keyboard may require specialized features such as a membrane keyboard, for durability and customization reasons.

For the foregoing reasons, it would be desirable to devise an improved pointing device which is not only highly reliable, but is also highly resistant to damage as well (either intentional or accidental). It would be further advantageous if the design were easily adaptable for use in many different environments (stationary) and target market segments.

### SUMMARY OF THE INVENTION

It is therefore one object of the present invention to provide an improved pointing device for controlling the movement of a graphical pointer on a display of a computer system.

It is another object of the present invention to provide such a pointing device that has fewer moving parts and is more difficult to damage or disable.

It is yet another object of the present invention to provide such a pointing device that is adapted for use in crowded environments where little space is available for such a device.

The foregoing objects are achieved in a pointing device for registering a desired direction of movement of a graphical pointer on a display of a computer system, generally comprising a base, a vertical member secured to the base, a pad mounted on the member such that manual pressure at a point near a periphery of said pad causes deflection of the member in a direction toward the pressure point, and appropriate electronics for translating a pitch angle of the vertical member into electrical signals, which can then be conveyed to a controller of the computer system. At least one actuation button is mounted to the base to allow selection of objects on the display, or other mouse operations. The pad is preferably located within a recessed portion of the base, and deflection of the pad is limited by an adjacent recessed surface and a rim of the base. The pointing device of the present invention has essentially no moving parts, and so is highly reliable and resistant to damage and is well suited to environments where space is a premium.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein:

FIG. 1 is a top plan view of one embodiment of a pointing device for a computer system according to the present invention; and

FIG. 2 is a longitudinal sectional view of the pointing device of FIG. 1.

### DESCRIPTION OF AN ILLUSTRATIVE EMBODIMENT

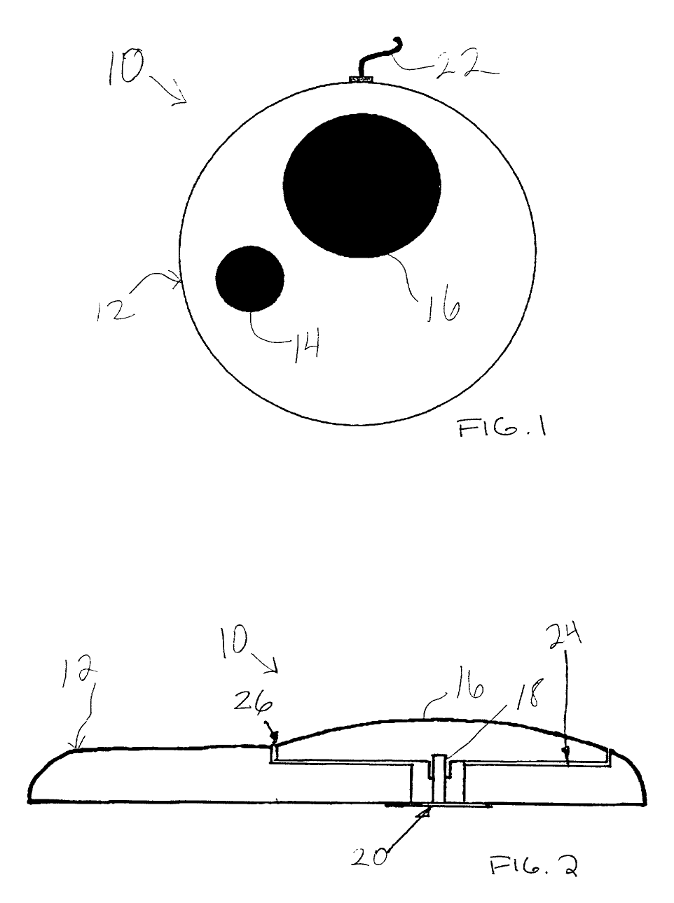

With reference now to the figures, and in particular with reference to FIG. 1, there is depicted one embodiment 10 of the pointer device of the present invention. Pointer device 10 is adapted for use with a computer system having a visual display, wherein the computer system executes an operating system or application program that provides a graphical pointer on the visual display. The details of the remainder of the computer system are omitted here since they are generally conventional and well-known. However, while the present invention can be used with a computer system whose other components are conventional, the present invention could also be applied to computer systems that are not necessarily conventional, i.e., they could include new hardware components or have a novel interconnection architecture for existing components. Therefore, those skilled in the art will appreciate that the present invention is not limited in application to any specific computer system.

Pointer device 10 is generally comprised of a housing or base 12 having one or more actuation buttons 14 and a disk or pad 16. As further seen in FIG. 2, pad 16 is mounted to the top of a joystick-type member 18 which is secured to a plate 20 attached to the bottom surface of base 12. Joystick 18 operates in a manner similar to the IBM Trackpoint pointing device, in that it registers desired movements of the graphical pointer on the display device based on the pitch angle of the joystick, which is biased to stay in an essentially vertical position (zero pitch angle) when it is not being used.

Conventional electronics may be located within base 12 to translate the pitch angle of joystick 18 into electrical signals which may be conveyed to the computer via a wire 22 or other means including, but not limited to, infrared (IR) or radiofrequency (RF) signals. The signals are sensed by an input/output (I/O) controller (not shown) which is connected to the computer's central processing unit (CPU); the CPU interprets the signals and sends appropriate data to a display adapter which then causes “movement” of the graphical pointer on the display. A software driver can be used to adjust mouse speed and acceleration, or electronics may be added to pointing device 10 so that the operating characteristics of the mouse are contained in and controlled by the mouse, eliminating the need for software drivers which are not universally available and can become obsolete.

Pad 16 is actuated by pressing near its periphery, which causes the cursor on the screen to move in the same direction as the vector drawn from the center of pad 16 to the point of manual pressure on its periphery. The maximum deflection of joystick 18 is determined by the size of pad 16 and the distance between the bottom of pad 16 and the recessed surface 24 of base 12. A cavity is provided in base 12 with sufficient space for deflection of joystick 16. Items on screen can be selected using button 14, which is placed on base 12 in a location that is convenient to reach and actuate.

Damage to pointing device 10 is prevented by restricting the x-y displacement of pad 16 with a rim 26 fashioned into the recess of base 12, and by limiting the deflection of the stick as described earlier. Rotation of pad 16 may be minimized by recessing the pad into the base, thus eliminating peripheral edges from being exposed and gripped. Further, joystick 18 can be made with a circular cross-section to allow pad 16 to freely rotate thereon.

In order to return joystick 16 to an unstressed (upright) position, mechanical assistance may be provided in one of several ways. A thin formation may be used under pad 16, providing a gentle, uniform restoring force; a columnar spring surrounding joystick 16 may be used; individual coil or leaf springs could be used around the periphery of pad 16; or extensions and variations of these ideas.

Base 12 may be constructed of any durable material, preferably a polymer such as high density polyethylene, polyester, polycarbonate, etc. Pad 16 may also be constructed of any durable material, particularly polyurethane foam. In the illustrative embodiment, base 12 is generally circular, and the buttons 14 and pad 16 are also generally circular (oval). The size of pointing device 10 is preferably selected to comfortably support the entire hand, e.g., a radius of 6 cm. The specific design may be selected for different intended market segments and usage environments. For instance, a general consumer implementation might have one appearance (including shape and color scheme), a child's version for day care might have another look, and a unit designed for seniors or people with limited manual dexterity might have a third, with larger buttons and pads. The units may be designed in arbitrary or fanciful shapes, such as animals, sports team logos, etc. Also, the communication medium of a conventional mousepad may be built into device 10. A product extension would be to incorporate this device into computer furniture, kiosks, keyboards, embedded devices, toys or other products related to computers such as web (Internet) applicances, phones, televisions, etc.

Pointing device 10 possesses many advantages over the prior art. It has essentially no moving parts, thus being highly reliable as well as resistant to damage, whether intentional or accidental. It is well suited to environments where space is a premium. It is also expected that there are ergonomic benefits imparted by support of the entire hand on base 12, and other ergonomic considerations may be used to alter the basic design. Since it has no balls or removable tips, it does not present any choking hazard for small children.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. For example, while the present invention is particularly suited for use with so-called personal computers (PCs), it is more generally applicable to any type of data processing system which provides a graphical pointer for any type of visual display. It is therefore contemplated that such modifications can be made without departing from the spirit or scope of the present invention as defined in the appended claims.

1. An article comprising:
a base having a generally flat bottom for resting on a surface; and
means supported on said base for converting a pressure point into a direction vector.

2. The article of claim 1 further comprising at least one actuation button mounted on said base.

3. The article of claim 1 further comprising means, located within base, for translating said direction vector into electrical signals.

4. The article of claim 1 wherein said converting means comprises:
a joystick secured on said base with sufficient space around said joystick to allow deflection thereof; and
a pad mounted on said joystick such that manual pressure at a point near a periphery of said pad causes deflection of said joystick in a direction toward said pressure point.

5. The article of claim 4 wherein said pad is generally circular and mounted centrally on said joystick.

6. The article of claim 4 wherein deflection of said pad is limited by an adjacent surface of said base.

7. The article of claim 4 wherein said joystick has a circular cross-section such that said pad may freely rotate thereon.

8. The article of claim 4 further comprising means for biasing said joystick to an unstressed position.

9. The article of claim 4 wherein said base has a recessed portion receiving said pad.

10. The article of claim 9 wherein said base further has a rim surrounding said periphery of said pad.

11. A device for registering a desired direction of movement of a graphical pointer on a display of a computer system, comprising:
a housing;
a joystick member secured to said housing;
a pad mounted on said joystick member such that manual pressure at a point near a periphery of said pad causes deflection of said joystick member in a direction toward said pressure point; and
means, located within housing, for translating a pitch angle of said joystick into electrical signals.

12. The device of claim 11 further comprising at least one actuation button mounted to said housing.

13. The device of claim 11 wherein said pad is generally circular and mounted centrally on said joystick member.

14. The device of claim 11 wherein deflection of said pad is limited by an adjacent surface of said housing.

15. The device of claim 11 wherein said joystick member has a circular cross-section such that said pad may freely rotate thereon.

16. The device of claim 11 further comprising means for biasing said joystick member to an unstressed position.

17. The device of claim 11 wherein said housing has a recessed portion receiving said pad.

18. The device of claim 11 wherein said housing further has a rim surrounding said periphery of said pad.

19. A pointing device for a computer system comprising:
a base having a generally flat bottom for resting on a surface, constructed of a polymeric material, and being sized to support a hand;
a joystick secured within a cavity of said base having sufficient space to allow deflection of said joystick;
a generally circular pad mounted centrally on said joystick such that manual pressure at a point near a periphery of said pad causes deflection of said joystick in a direction toward said pressure point, said pad being located in a recessed portion of said base, and deflection of said pad being limited by an adjacent surface of said base and a rim of said base which surrounds said periphery of said pad, said joystick further having a circular cross-section such that said pad may freely rotate thereon;
means for biasing said joystick to an unstressed position;
means, located within housing, for translating a pitch angle of said joystick into electrical signals;
at least one actuation button mounted on said base; and
means for conveying electrical signals to a controller of a computer system.
